(19) United States
(12) Patent Application Publication
(10) Pub. No.: US 2009/0237698 A1
(43) Pub. Date: Sep. 24, 2009

(54) IMAGE PROCESSING DEVICE AND INITIATING METHOD THEREFOR

(75) Inventor: Yao-Hui Huang, Taoyuan Hsien (TW)

Correspondence Address: KIRTON AND MCCONKIE, 60 EAST SOUTH TEMPLE,, SUITE 1800, SALT LAKE CITY, UT, 84111, US

(73) Assignee: TECO IMAGE SYSTEM CO., LTD., Taoyuan Hsien (TW)

(21) Appl. No.: 12/195,162

(22) Filed: Aug. 20, 2008

(30) Foreign Application Priority Data
Mar. 19, 2008 (TW) 097109716

(51) Int. Cl. G06F 3/12

(52) U.S. Cl. 358/1.13

(57) ABSTRACT

The present invention provides an initiating method for an image processing device. The image processing device includes a memory unit, a storage unit for storing multiple compressed programs therein, and a controller connected to the storage unit and the memory unit. The initiating method includes steps of: (a) selectively reading out at least one compressed program and loading the at least one compressed program into the memory unit; (b) executing a decompression program to decompress the at least one compressed program; and (c) executing the at least one compressed program which has been decompressed.

### FIELD OF THE INVENTION

The present invention relates to an initiating method, and more particularly to an initiating method for an image processing device.

### BACKGROUND OF THE INVENTION

Image processing devices such as multifunction peripherals, copy machines, printers, fax machines or scanners are widely used for processing (e.g. copying, scanning, faxing or printing) various documents.

Generally, an image processing device comprises a controller, a flash memory, a display unit, a dynamic random access memory (DRAM), an input unit, and several circuit modules, circuit units or integrated chips (functional chips) with diverse functions. By specified function programs such as copying programs, scanning programs, faxing programs and printing programs, the image processing device can execute associated functions (e.g. copying, scanning, faxing or printing functions).

Nowadays, the image processing device usually has expanded function in order for complying with diversified purposes. As a consequence, the flash memory should have increased memory capacity for storing desired function programs therein. The typical memory capacity of the flash memory is in a power series relation, e.g. 1M, 2M, 4M, 8M, 16M, 32M, 64M, 128M, 256M bytes. In a case that the memory capacity for storing desired function programs is 17M bytes, the flash memory with memory capacity of 16 M fails to be used but the flash memory with memory capacity of 32 M is usually selected. Since the 32 M-sized flash memory is much more costly than the 16 M-sized flash memory, the selection of the 32 M-sized flash memory adds extra cost.

Furthermore, when function programs are executed, the prompt messages associated with the function programs will be shown on the display unit of the image processing device. For example, in a case that the user intends to use the image processing device to generate two copies of the document, the image processing device will execute the copying programs and then a prompt message “Please input the number of copies” will be shown on the display unit. After the copying function is executed, a prompt message “The copying function has been implemented” will be shown on the display unit. For selling the image processing device to all countries or regions over the world, the prompt messages should be shown in various languages. For complying with the prompt messages in various languages, corresponding function programs should be refreshed and modified. As known, it is very complicated and difficult to refresh and modify the function programs.

Furthermore, all programs have been previously stored in the storage unit of the conventional image processing device. When the conventional image processing device is powered on, all programs stored in the storage unit will be loaded into a random-access memory. Via the input unit, selective instructions can be inputted to execute corresponding function programs. Since the memory capacity of the random-access memory should be greater than or equal to that of the flash memory, the cost of the image processing device is increased. Moreover, since the procedure of loading of programs into the random-access memory is very time-consuming, the time period of initiating the image processing device is extended.

There is a need of providing an initiating method for an image processing device to obviate the drawbacks encountered from the prior art.

### SUMMARY OF THE INVENTION

It is an object of the present invention to provide an initiating method for an image processing device. By the initiating method, the memory capacity required for the storage unit and the memory unit can be reduced, so that the image processing device is more cost-effective and the programmer can refresh or modify the contents of the prompt messages or the function programs without difficulty.

Another object of the present invention provides an initiating method for an image processing device so as to shorten the time period of booting the image processing device.

In accordance with an aspect of the present invention, there is provided an initiating method for an image processing device. The image processing device includes a memory unit, a storage unit for storing multiple compressed programs therein, and a controller connected to the storage unit and the memory unit. The initiating method includes steps of: (a) selectively reading out at least one compressed program and loading the at least one compressed program into the memory unit; (b) executing a decompression program to decompress the at least one compressed program; and (c) executing the at least one compressed program which has been decompressed.

In accordance with another aspect of the present invention, there is provided an image processing device. The image processing device comprises a memory unit; a storage unit for storing multiple compressed programs therein; and a controller connected to the storage unit and the memory unit for performing an initiating procedure comprising steps of: (a) selectively reading out at least one compressed program and loading the at least one compressed program into the memory unit; (b) executing a decompression program to decompress the at least one compressed program; and (c) executing the at least one compressed program which has been decompressed.

The above contents of the present invention will become more readily apparent to those ordinarily skilled in the art after reviewing the following detailed description and accompanying drawings, in which:

### BRIEF DESCRIPTION OF THE DRAWINGS

FIG. 1 is a schematic architecture illustrating an image processing device according to a preferred embodiment of the present invention;

FIG. 2 is a schematic architecture illustrating an image processing device according to another preferred embodiment of the present invention;

FIG. 3 is a schematic functional block diagram illustrating layout configurations of various function programs, message files and parameter data; and

FIG. 4 is a flowchart illustrating an initiating method for the image processing device of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

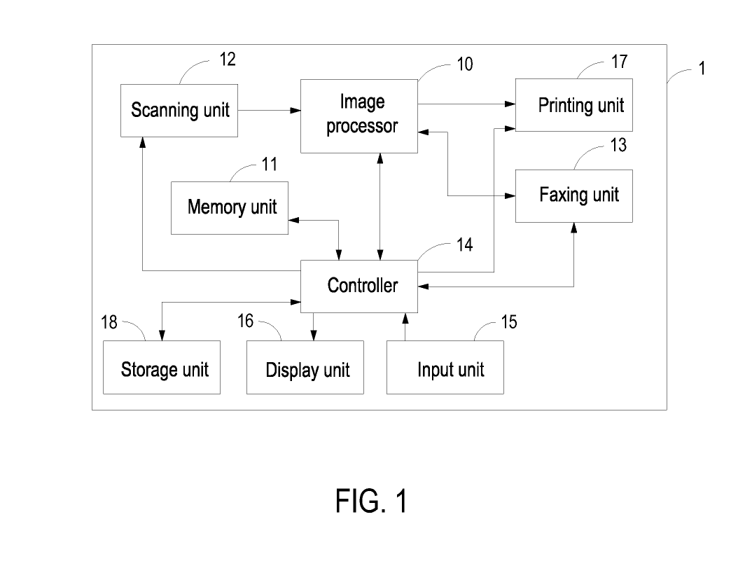

Referring to FIG. 1, a schematic architecture of an image processing device according to a preferred embodiment of the present invention is illustrated. As shown in FIG. 1, the image processing device 1 is for example a multifunction peripheral and principally comprises an image processor 10, a memory unit 11, a scanning unit 12, a faxing unit 13, a controller 14, an input unit 15, a display unit 16, a printing unit 17 and a storage unit 18.

The image processor 10 is connected to the scanning unit 12, the faxing unit 13, the controller 14 and the printing unit 17 for processing image data. The scanning unit 12 is connected to the image processor 10 and the controller 14. The scanning unit 12 has an image scan region (not shown) for capturing the image of the document. The faxing unit 13 is also connected to the image processor 10 and the controller 14. The images processed by the image processor 10 are sent to the faxing unit 13 and then transmitted to the receiving terminal via PSTN (Public Switched Telephone Network) or Internet. Alternatively, the faxing unit 13 can receive image data from other image processing devices. The controller 14 is connected to the image processor 10, the memory unit 11, the scanning unit 12, the faxing unit 13, the input unit 15, the display unit 16, the printing unit 17 and the storage unit 18 for controlling operations of the image processing device 1. In some embodiments, the image processor 10 and the controller 14 can be integrated into a single controlling and processing unit such as a system on chip (SOC). The input unit 15 and the display unit 16 are connected to the controller 14. The user can input instructions and select desired functions via the input unit 15 and messages associated with operations of the image processing device 1 can be shown on the display unit 16. In some embodiments, the input unit 15 and the display unit 16 are integrated into an input and display unit such as a touch panel. The printing unit 17 is connected to the image processor 10 and the controller 14. Under control of the controller 14, the images processed by the image processor 10 can be printed out through the printing unit 17.

The storage unit 18 is for example a flash memory, a read-only memory (ROM) or other memory with data-storing capability. The storage unit 18 is connected to the controller 14 for storing function programs, message files and parameter data. The function programs includes for example boot programs, copying programs, scanning programs, faxing programs, printing programs, network programs and the like. The message files include various prompt message files in different languages. The parameter data include boot parameter data and function program parameter data.

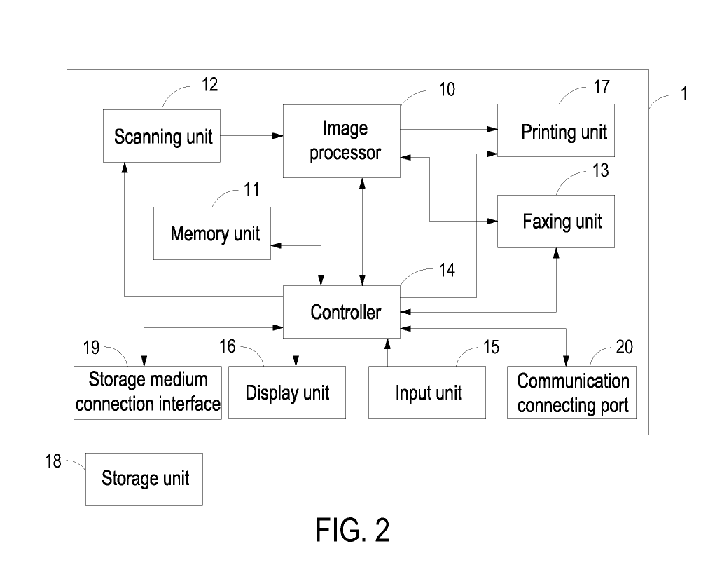

In some embodiments, as shown in FIG. 2, a storage medium connection interface 19 is interconnected between the image processing device 1 and the storage unit 18. Through the storage medium connection interface 19, the data stored in the storage unit 18 is accessible to the controller 14. An example of the storage medium connection interface 19 includes but is not limited to an universal serial bus (USB), an I-Link interface (e.g. IEEE 1394) or a secure digital (SD)/memory stick (MS)/multi media card (MMC) all in one carder reader interface. The storage unit 18 can be selectively arranged inside or outside the image processing device 1. In some embodiments, the image processing device 1 further comprises at least a communication connecting port 20 such as an Ethernet port, a USB port and/or a printer port. The communication connecting port 20 is connected to the controller 14. Through the communication connecting port 20, the image processing device 1 can be communicated with other electronic devices linked to the communication connecting port 20.

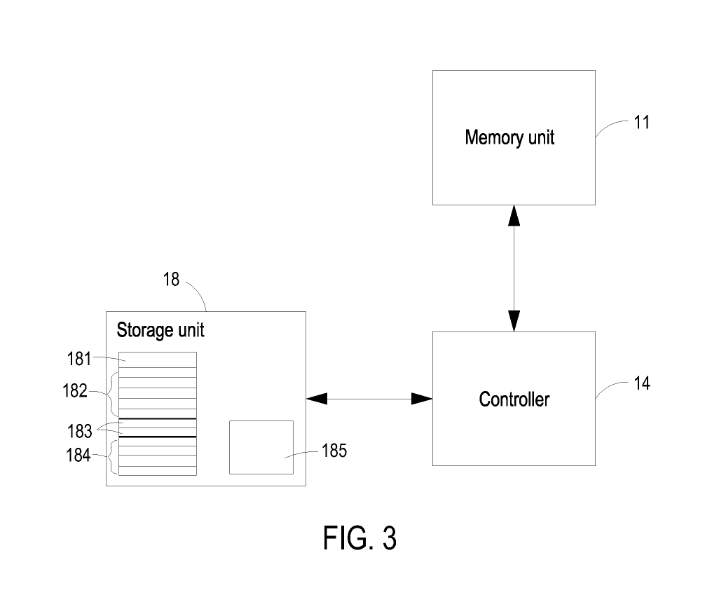

FIG. 3 is a schematic functional block diagram illustrating layout configurations of various function programs, message files and parameter data. As shown in FIG. 3, a boot program 181, other function programs 182 (e.g. copying programs, scanning programs, faxing programs, printing programs and/or network programs), parameter data 183 (boot parameter data and function program parameter data) and message files 184 (various prompt message files in different languages) are stored in respective regions of the storage unit 18. The contents of the message files 184 include for example the prompt messages associated with the copying programs, scanning programs, faxing programs or printing programs. These prompt messages are independent of the function programs 182 and can be included in several prompt message files in different languages. For example, the prompt message files may include Traditional Chinese prompt message files, Simplified Chinese prompt message files, English prompt message files, Japanese prompt message files, and so on. The contents of the message files 184 can be shown on the display unit 16 to suggest the user how to accurately operate the image processing device 1. The contents of the message files 184 can be shown in texts, pictures or animations. In other words, these message files 184 may have extension names of ‘txt’, ‘jpg’ or ‘gif’. Moreover, for each language, the prompt messages can be shown in various fonts. For example, the Traditional Chinese prompt message can be shown in Microsoft Mingliu, Microsoft JhengHei and the like.

For saving the memory space of the storage unit 18, the function programs 182 and the message files 184 can be compressed and then stored in the storage unit 18. For example, the storage unit 18 can store the boot programs, the parameter data, the compressed copying programs, the compressed Traditional Chinese prompt message files of the copying programs, the compressed Simplified Chinese prompt message files of the copying programs, the compressed English prompt message files of the copying programs, the compressed Japanese prompt message files of the copying programs, and the like. Depending on the functions of the image processing device 1, various function programs and various compressed message files are selectively stored in the storage unit 18.

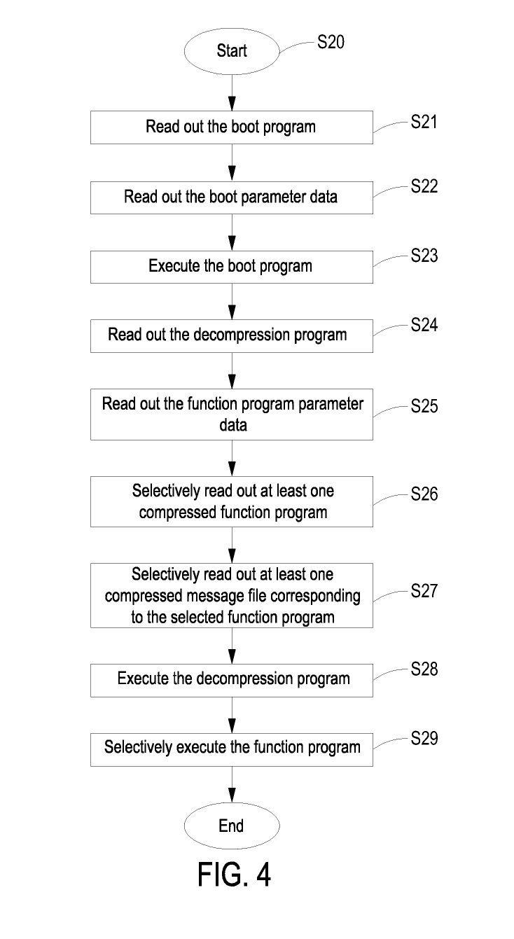

Hereinafter, an initiating method for the image processing device of the present invention will be illustrated with reference to the flowchart of FIG. 4 as well as FIGS. 1, 2 and 3.

After the image processing device 1 is powered on (Step S20), the controller 14 may access the storage unit 18 to read out the boot program such that the boot program is loaded into the memory unit 11 (Step S21). Next, the controller 14 may access the storage unit 18 to read out the boot parameter data (Step S22). The boot parameter data are then loaded into the memory unit 11. For example, the boot parameter data include but are not limited to the operating frequency of the controller 14, the operating frequency of the memory unit 11 and the bit rate of the faxing unit 13. Next, the controller 14 executes the boot program with the boot parameter data, thereby initialize the image processing device 1 (Step S23). As for the boot parameter data, the operating frequency of the controller 14 is 100M Hz, the operating frequency of the memory unit 11 is 133M Hz and the bit rate of the faxing unit 13 is 14400 bit/sec. Next, by the controller 14, the decompression program 185 is read out and loaded into the memory unit 11 (Step S24). Next, by the controller 14, the function program parameter data is read out and loaded into the memory unit 11 (Step S25). Examples of the function program parameter data include but are not limited to image contrast parameters, file storage data and the like. When the copying program is executed, the contrast of the copied image is adjusted according to the image contrast parameters. The file storage data contain the recording data associated with the compressed function program files and the compressed message files which are stored in the storage unit 18. According to the file storage data, the controller 14 can accurately read out the compressed function program files and the compressed message files. Next, by the controller 14, at least one compressed function program is selectively read out and loaded into the memory unit 11 (Step S26). Next, the controller 14 will selectively read out at least one compressed message file corresponding to the selected function program (Step S27). Next, the decompression program 185 is executed to selectively decompress the compressed function program files and the compressed message files in the memory unit 11 (Step S28). Afterwards, the function programs are selectively executed to implement selected image processing functions (e.g. copying, scanning, faxing or printing) according to the function program parameter data (Step S29).

In the above flowchart, the steps S21-S23 involve the steps of executing the boot program of the image processing device 1. The steps S24-S29 involve the steps of executing the function programs of the image processing device 1. In some embodiments, the decompression program is necessary because the function program files and the message files are stored in the storage unit 18 in compressed forms. Alternatively, the decompression program can be included in the boot program and thus the step S24 can be dispensed with.

In some embodiments, in the steps S26 and S28, the controller 14 can load all compressed function program files into the memory unit 11 and decompress the compressed function program files. Alternatively, in the steps S26 and S28, the controller 14 can load some of the compressed function program files into the memory unit 11 and decompress such compressed function program files. In some embodiments, in the steps S27 and S28, the controller 14 can load all compressed message files associated with the read function programs into the memory unit It and decompress such compressed message files. Alternatively, in the steps S27 and S28, the controller 14 can load at least one compressed message file associated with the read function programs into the memory unit It and decompress the at least one compressed message file.

In some embodiments, the function programs are executed after the user inputs selective instruction through the input unit 16 of the image processing device 1. For example, in response to a specified selective instruction associated with the copying function, the controller 14 will execute the copying program. Under this circumstance, the step S29 may further include a sub-step of receiving and discriminating selective instructions by the controller 14, and then selectively executing function programs in response to the selective instructions. The selective instructions can be inputted via the input unit 15. Alternatively, the selective instructions can be generated and transmitted from the faxing unit 13 or the communication connecting port 20. For example, for receiving a facsimile document, the faxing unit 13 will generate a selective instruction associated with receipt of the facsimile document. In response to such selective instruction, the image processing device 1 will execute the function of receiving the facsimile document. Moreover, for printing a document, the communication connecting port 20 should be linked to a computer such that a selective instruction associated with printing of the document will be transmitted from the computer to the image processing device 1 through the communication connecting port 20. In response to such selective instruction, the image processing device 1 will execute the function of printing the facsimile document.

From the above description, since the prompt messages conventionally included in the function programs are separated as at least one independent message file and the function programs and the message file are compressed, the storage unit of the image processing device of the present invention may have reduced memory capacity so as to achieve the purpose of cost-effectiveness. Moreover, by selectively loading the compressed function program files and the compressed message files into the memory unit and then decompressing these compressed files, the memory unit can have small-sized memory capacity. As previously described, the conventional initiating method should load all function programs into the memory unit when the image processing device is booted. On the contrary, since the boot program, requisite parameter data, selected function programs and requisite message files are loaded into the memory unit and decompressed, the loading time period is reduced. In other words, the initiating method of the present invention is more time-saving in comparison with the prior art method. Moreover, the programmer can refresh or modify the contents of the prompt messages or the function programs without difficulty by using the method of the present invention.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An initiating method for an image processing device, said image processing device comprising a memory unit, a storage unit for storing multiple compressed programs therein, and a controller connected to said storage unit and said memory unit, said initiating method comprising steps of:
(a) selectively reading out at least one compressed program and loading said at least one compressed program into said memory unit;
(b) executing a decompression program to decompress said at least one compressed program; and
(c) executing said at least one compressed program which has been decompressed.

2. The initiating method according to claim 1 wherein said storage unit further stores a boot program and a boot parameter data, and before said step (a), said initiating method further comprises steps of:
reading out said boot program and said boot parameter data, and loading said boot program and said boot parameter data into said memory unit; and
executing said boot program, thereby initiating said image processing device.

3. The initiating method according to claim 2 wherein said boot parameter data include the operating frequency of said controller and the operating frequency of said memory unit.

4. The initiating method according to claim 2 wherein said decompression program is included in said boot program.

5. The initiating method according to claim 2 wherein said decompression program is included in said storage unit.

6. The initiating method according to claim 5 wherein said step (b) further comprises sub-steps of:
(b1) reading out said decompression program, and loading said decompression program into said memory unit; and
(b2) executing said decompression program to decompress said at least one compressed program.

7. The initiating method according to claim 1 wherein said multiple compressed programs comprise multiple compressed function programs.

8. The initiating method according to claim 7 wherein said multiple compressed function programs comprise copying programs, scanning programs, faxing programs, printing programs and network programs.

9. The initiating method according to claim 7 wherein said storage unit further stores multiple compressed message files, and said image processing device further comprises a display unit for showing contents of said message files.

10. The initiating method according to claim 9 wherein said message files are prompt message files, which are written as text files, picture files or animation files.

11. The initiating method according to claim 10 wherein said step (a) further comprises sub-steps of:
(a1) selectively reading out at least one compressed function program, and loading said compressed function program into said memory unit; and
(a2) selectively reading out at least one compressed message file of said at least one compressed function program, and loading said compressed message file into said memory unit.

12. The initiating method according to claim 11 wherein said storage unit further stores a program parameter data.

13. The initiating method according to claim 12 wherein said step (a) further comprises a sub-step (a3) of reading out said program parameter data and loading said program parameter data into said memory unit.

14. The initiating method according to claim 1 wherein said storage unit is a flash memory, a read-only memory or other memory with data-storing capability.

15. An image processing device, comprising:
a memory unit;
a storage unit for storing multiple compressed programs therein; and
a controller connected to said storage unit and said memory unit for performing an initiating procedure, said initiating procedure comprising steps of:
(a) selectively reading out at least one compressed program and loading said at least one compressed program into said memory unit;
(b) executing a decompression program to decompress said at least one compressed program; and
(c) executing said at least one compressed program which has been decompressed.

16. The image processing device according to claim 15 further comprising an image processor connected to said controller for processing image data.

17. The image processing device according to claim 15 wherein said storage unit is a flash memory, a read-only memory or other memory with data-storing capability.

18. The image processing device according to claim 15 further comprising an input unit, a faxing unit, a scanning unit and a printing unit connected to said controller, respectively.

19. The image processing device according to claim 15 further comprising a communication connecting port connected to said controller.

20. The image processing device according to claim 15 further comprising a display unit connected to said controller.
